(19) United States
(12) Patent Application Publication
(10) Pub. No.: US 2017/0235274 A1
(43) Pub. Date: Aug. 17, 2017

(54) Methods for Remanufacturing Imaging Components

(71) Applicant: Static Control Components, Inc., Sanford, NC (US)

(72) Inventors: Stephen Joseph Daniels, Sanford, NC (US); Robert Farmer, Hope Mills, NC (US); Christopher Elton Nichols, Lillington, NC (US); Derick Keith Dove, Sanford, NC (US); Roderick Craig Boone, Fuquay Varina, NC (US)

(21) Appl. No.: 15/586,616

(22) Filed: May 4, 2017

Related U.S. Application Data
(63) Continuation-in-part of application No. 15/131,582, filed on Apr. 18, 2016.
(60) Provisional application No. 62/150,005, filed on Apr. 20, 2015.
(60) Provisional application No. 62/150,995, filed on Apr. 22, 2015.
(60) Provisional application No. 62/151,591, filed on Apr. 23, 2015.

(51) Int. Cl. G03G 21/18

(52) U.S. Cl. CPC G03G 21/181

(57) ABSTRACT

A method of remanufacturing an imaging cartridge comprising a toner hopper having a toner bag and not having a seal port, the method comprising forming a seal port in the toner hopper; disposing a replacement toner container in the toner hopper, the replacement toner container including a removable seal having a seal tail; inserting a portion of the seal tail through the seal port and repairing a broken doctor blade contact

The present application claims the benefit of and is a continuation-in-part of U.S. patent application Ser. No. 15/131,582 filed Apr. 18, 2016, which claims the benefit of U.S. Provisional Patent Application Ser. No. 62/150,005 filed Apr. 20, 2015, U.S. Provisional Patent Application Ser. No. 62/150,995 filed Apr. 22, 2015, and U.S. Provisional Patent Application Ser. No. 62/151,591 filed Apr. 23, 2015, each of which is incorporated by reference herein in its entirety.

### BACKGROUND

Cartridge seals prevent toner from leaking out of the toner cartridge during shipping and handling. Cartridge seals are removed either by the end user or automatically by the printer prior to printing. During remanufacturing of a cartridge it is necessary to replace the cartridge seal so that the cartridge can once again be shipped without the fear of toner leaking out of the cartridge.

The HP M252/277 (201A/201X cartridge) contains a sealed bag filled with toner which is much different than most traditional methods of sealing toner within a cartridge. The seal is attached to the bag by some method of heat and the tail end of the seal is attached to the tone agitator shaft that runs through the cartridge. Once the cartridge is installed into the printer the printer engages a drive gear that is attached to agitator shaft and removes the seal from the bag. The seal then acts as a toner agitator paddle for the remainder of the toner life. The present application provides advantageous methods and apparatus for sealing toner within a toner cartridge, such as the HP M252/277 (201A/201X) cartridge, during the remanufacturing process.

### BRIEF DESCRIPTION OF THE DRAWINGS

FIG. 1 shows an isometric view of a toner bag (also referred to as “bag”), toner bag seal (also referred to as “seal”, “toner seal” or “removable seal”) and agitator in accordance with aspects of multiple embodiments of the present invention.

FIG. 2 shows an isometric wire-line view of a toner bag, toner bag seal and agitator in accordance with aspects of multiple embodiments of the present invention.

FIGS. 3-8 show particular embodiments of a toner bag replacement and toner bag seal replacement in accordance with aspects of multiple embodiments of the present invention.

FIGS. 9A-9C show a toner bag replacement and toner bag seal replacement in accordance with aspects of multiple embodiments of the present invention.

FIG. 10 shows a toner cartridge with exemplary pull tabs for pulling to form an opening in a toner container housed in the toner cartridge in accordance with aspects of the present invention.

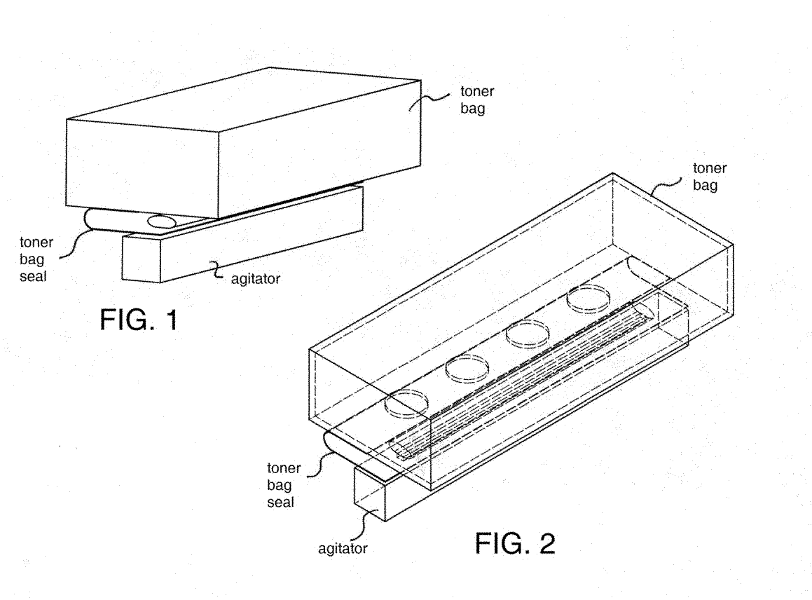

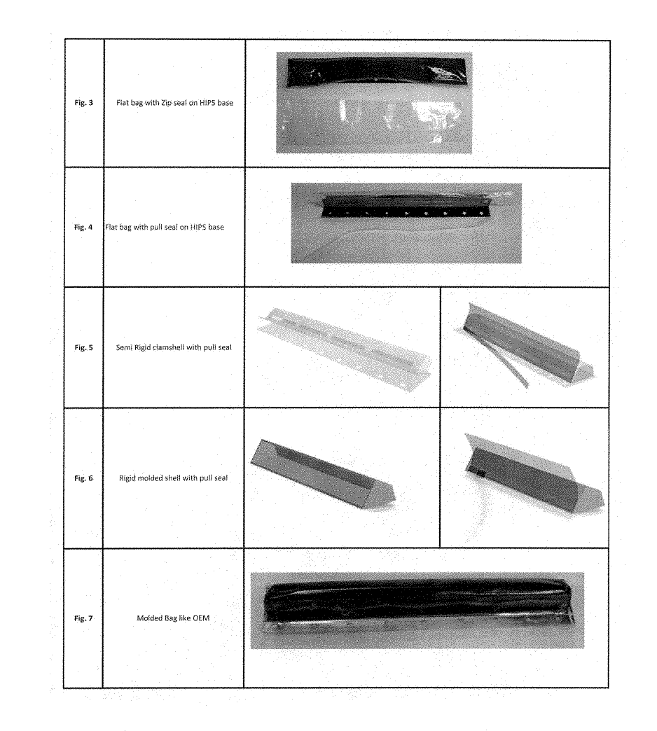

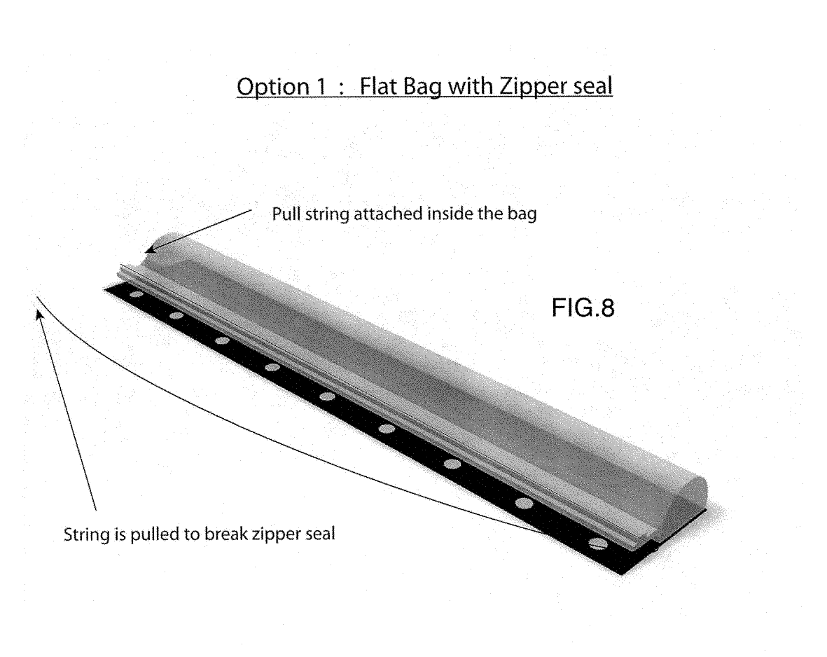

### DETAILED DESCRIPTION

### Exemplary Methods for Sealing Cartridge

In one aspect of the present invention, the Original Equipment Manufacturer (OEM) toner bag and seal can be reused to seal the toner within the cartridge. The OEM bag can be removed from the hopper or left in place during this process. The OEM bag should be cleaned out thoroughly to remove any residual toner. The OEM seal can be reapplied to the OEM bag using adhesive, glue, or a heat method such as heat stake or ultrasonic welding. Toner can either be filled into the bag using the existing toner port prior to applying the seal or a small slit can be made in the bag to add toner. If a small slit is made then it can be sealed either by adhesive, glue, or a heat method.

In another aspect of the present invention, the OEM bag and seal can be reused to seal the toner within the cartridge. The OEM bag can be removed from the hopper or left in place during this process. The OEM bag should be cleaned out thoroughly to remove any residual toner. The OEM seal can be trimmed to remove the portion where the seal was originally applied to the bag. A new never used portion of the OEM seal can then be applied to the OEM bag using adhesive, glue, or a heat method such as heat stake or ultrasonic welding. Toner can either be filled into the bag using the existing toner port prior to applying the seal or a small slit can be made in the bag to add toner. If a small slit is made then it can be sealed either by adhesive, glue, or a heat method.

In another aspect of the present invention, a new bag and removable seal can be used to seal the toner within the cartridge. The bag can be made out of plastic, foil, or any other suitable flexible material. The new bag can be installed within the cartridge using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. A seal can be either integrated into the bag or can be attached to the outer portion of the bag via adhesive, glue, or heat method. The end of the seal can be attached to the agitator shaft. Once the printer begins rotating the agitator, the seal will be pulled thus opening the port on the bag and allowing toner to flow freely to the developing components. Depending on the shape or design of the seal it can become a toner agitator paddle (much like the OEM) or the ribbon or pull strip can be coiled/wrapped around the agitator and serve no further purpose.

In another aspect of the present invention, toner can be filled directly into the hopper. The OEM used bag and seal can remain in their current positions. The developing components within the HP252/277 (201A/201X) cartridge all contact each other therefore providing a seal/barrier that prevents toner from leaking out of the cartridge.

In another aspect of the present invention, toner can be filled directly into the OEM toner bag located within the hopper without any disassembly required. This will allow toner to enter the hopper without being impeded by the OEM used bag. The OEM used bag, agitator, and seal can remain in their current positions. The toner can be filled into the bag through a hole placed through both the surface of the hopper and the bag. The hole can be created via drilling or heated tooling. The hole can be sealed with a plug or adhesive backed seal. The developing components within the HP252/277 (201A/201X) cartridge all contact each other therefore providing a seal/barrier that prevents toner from leaking out of the cartridge.

In another aspect of the present invention, a hard casing can be used to seal the toner within the cartridge. The casing can be made of plastic, metal, or any other suitable rigid material. The casing can be attached within the cartridge using the same method the OEM uses or it can be attached to the cartridge by adhesive, glue, or a heat method. Toner can be filled into the casing through the port prior to installing a seal or through a separate port that can be sealed using a screw on cap, plug, adhesive, glue, or heat method. A removable seal can be attached to the outer portion of the casing via adhesive, glue, or heat method. The end of the seal can be attached to the agitator shaft. Once the printer begins rotating, the agitator the seal will be pulled thus opening the port on the casing and allowing toner to flow freely to the developing components. Depending on the shape or design of the seal it can become a toner agitator paddle (much like the OEM) or the ribbon or pull strip can be coiled/wrapped around the agitator and serve no further purpose.

In another aspect of the present invention, a barrier with port holes can be added within the hopper. The barrier would be placed between the developing components and the agitator shaft within the hopper. The barrier can be made of plastic, metal, or any other suitable rigid material. The barrier can be attached to the hopper using adhesive, glue or a heat method. A seal can be attached to the inner or outer portion of the barrier via adhesive, glue, or heat method. If the seal is attached to the inner portion (closest to the agitator shaft) of the barrier then the end of the seal can be attached to the agitator shaft. Once the printer begins rotating the agitator the seal will be pulled thus opening the port on the barrier and allowing toner to flow freely to the developing components. Depending on the shape or design of the seal it can become a toner agitator paddle (much like the OEM) or the ribbon or pull strip can be coiled/wrapped around the agitator and serve no further purpose. If the seal is attached to the outer portion (closest to the developing components) of the barrier then the seal will need to be pulled manually by the end user. To allow the end user to pull the seal manually a slit will need to be cut in the hopper using a blade or rotary tool to feed the end of the seal out of the hopper. With the end of the seal extending out of the hopper the end user can now pull the seal prior to installing the cartridge into the printer thus opening the port on the barrier and allowing toner to flow freely to the developing components.

In another aspect of the present invention, a barrier with port holes can be added within the hopper. The barrier would be placed between the developing components and the agitator shaft within the hopper. The barrier can be made of plastic, metal, or any other suitable rigid material. The barrier can be attached to the hopper using adhesive, glue or a heat method. A plug can be installed to cover the barrier toner port holes. The plug can be made out of rubber, silicon, cloth, felt, foam, or any other suitable malleable material. The existing OEM seal can be attached to the back of the plug using glue, adhesive, or heat method. The existing OEM seal can also be removed and replaced with a new flexible material and this new material can be attached to the agitator shaft on one end will the other end is attached to the plug using adhesive, glue, heat method, or it can be integrated into the plug. Once the printer begins rotating the agitator, the plug will be pulled thus opening the port and allowing toner to flow freely to the developing components.

In another aspect of the present invention, a new bag and removable seal can be used to seal the toner within the cartridge. The bag can be made out of plastic, foil, or any other suitable flexible material. The new bag can be installed within the cartridge using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. A seal can be either integrated into the bag or can be attached to the outer portion of the bag via adhesive, glue, or heat method. The end of the seal can be pulled manually by the end user prior to printing. To allow the end user to pull the seal manually a slit can be cut in the hopper using a blade or rotary tool to feed the end of the seal out of the hopper or the end of the seal can be fed through the existing opening from where the hopper was split. With the end of the seal extending out of the hopper the end user can now pull the seal prior to installing the cartridge into the printer thus opening the port on the barrier and allowing toner to flow freely to the developing components.

In another aspect of the present invention, a hard casing can be used to seal the toner within the cartridge. The casing can be made of plastic, metal, or any other suitable rigid material. The casing can be attached within the cartridge using the same method the OEM uses or it can be attached to the cartridge by adhesive, glue, or a heat method. Toner can be filled into the casing through the port prior to installing a seal or through a separate port that can be sealed using a screw on cap, plug, adhesive, glue, or heat method. A seal can be attached to the outer portion of the casing via adhesive, glue, or heat method. The end of the seal can be pulled manually by the end user prior to printing. To allow the end user to pull the seal manually a slit can be cut in the hopper using a blade or rotary tool to feed the end of the seal out of the hopper or the end of the seal can be fed through the existing opening from where the hopper was split. With the end of the seal extending out of the hopper the end user can now pull the seal prior to installing the cartridge into the printer thus opening the port on the barrier and allowing toner to flow freely to the developing components.

In another aspect of the present invention, the OEM hopper could be completely replaced with a new hopper. The new hopper could be designed with a location to place an internal removable seal that attaches to the agitator shaft much like the HP M553 (508A/X cartridge) design and/or it could be designed with a location to place a removable seal behind the toner adder roller. With the seal placed behind the toner adder roller it would need to have a slot in the cartridge to insert the seal pull ribbon so that the seal could be removed from the cartridge allowing toner to flow freely to the developing components.

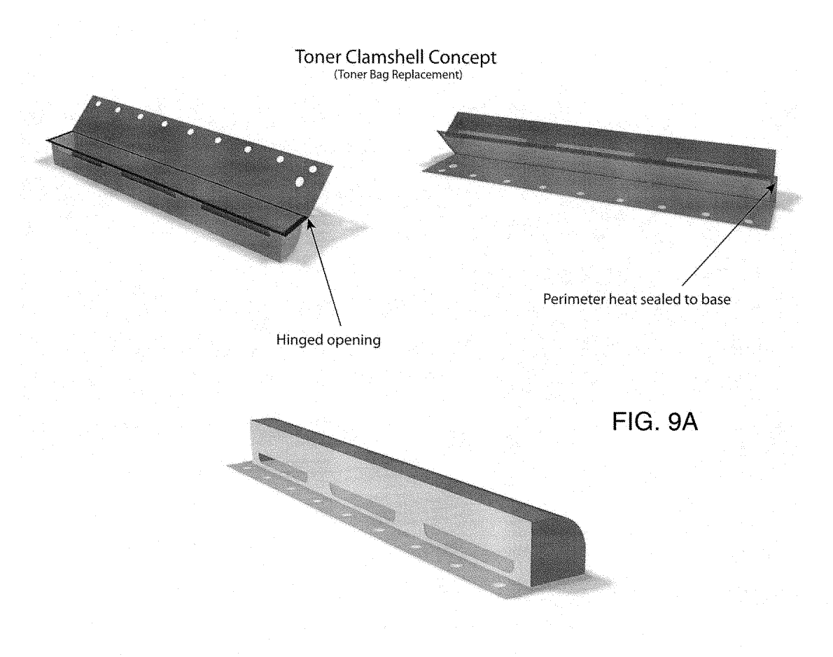

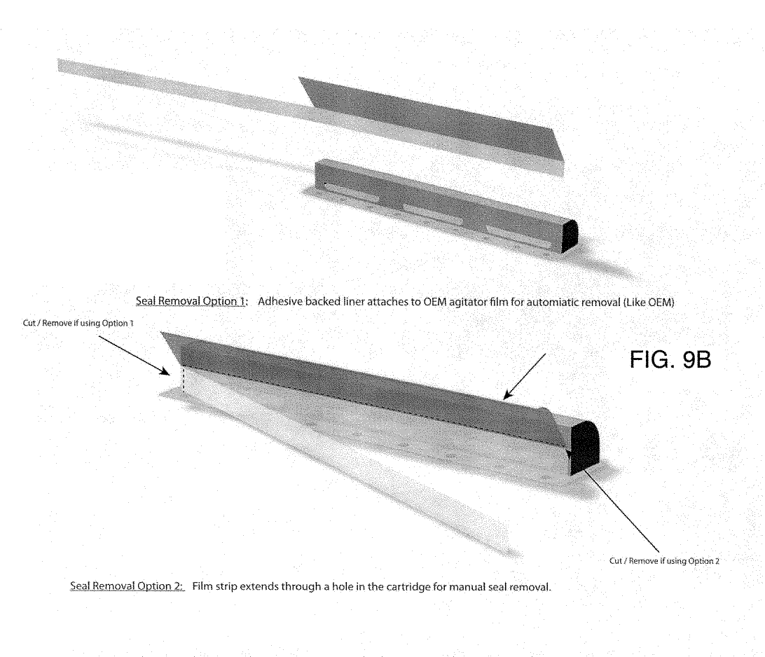

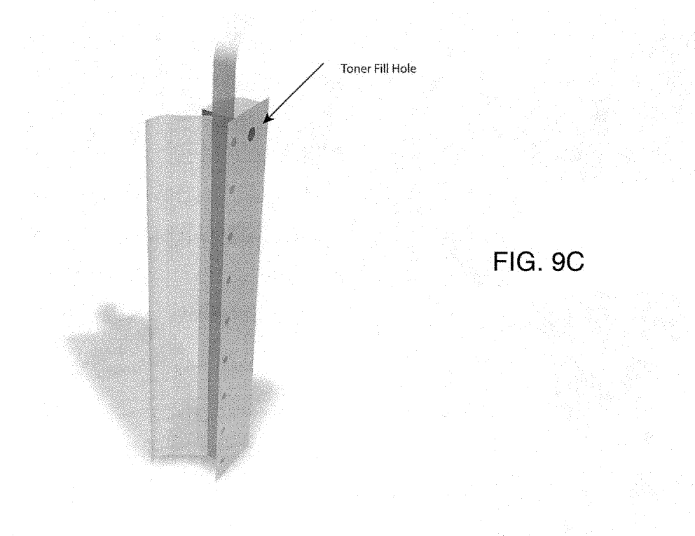

In another aspect of the present invention, a removable seal could be provided with two different options for removal. Providing two different options would give the remanufacturer the choice to use the method they prefer. The seal could be attached to the original OEM bag, a new bag, a hard casing, or a barrier within the hopper. The seal would have two different methods for removing the seal so that toner could flow freely to the developing components. One option would be to attach the seal to the agitator so that the seal is removed automatically when the printer engages the cartridge. The other option would be a pull ribbon that could be extended out from the cartridge either through a newly created slot or an existing slot. The pull ribbon would be pulled manually by the end user to remove the seal. Once the remanufacturer has decided the method in which they would like to pull the seal the other option could be removed from the seal by the remanufacturer to prevent issues. FIG. 9B shows an exemplary removable seal with two different options for removal.

In another aspect of the present invention, a new bag can be used to seal the toner within the hopper. The bag can be made out of plastic, foil, or any other suitable flexible material. The new bag can be installed within the hopper using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. A new plastic hopper can be designed to have a slot that runs the length of the cartridge or the OEM hopper can be modified to have a slot that runs the length of the cartridge. A blade with a handle can be attached or incorporated in the slot. The end user can move the handle down the length of the slot and the blade can cut open the bag allowing the toner to flow freely to the developing components. Or the end user can use their own blade to cut the bag open through the slot rather than having a blade incorporated in the hopper.

In another aspect of the present invention, a new bag and removable seal can be used to seal the toner within the cartridge. The bag can be made out of plastic, foil, or any other suitable flexible material. The new bag can be installed within the cartridge using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. A seal can be either integrated into the bag or can be attached to the outer portion of the bag via adhesive, glue, or heat method. The end of the seal can be attached to the original OEM seal which is still attached to the agitator shaft. Once the printer begins rotating the agitator, the OEM seal will pull the seal that is attached or incorporated into the bag thus opening the port on the bag and allowing toner to flow freely to the developing components. The seal that is removed from the bag will remain attached to the OEM seal and become an agitator paddle within the hopper.

In another aspect of the present invention, a new hopper section with integrated enclosure for containing the toner can be used. An OEM toner hopper may comprise two or more sections that are sonically welded together. Once the OEM hopper has been split into two sections, either one of the two OEM hopper sections can be pared with a brand new molded hopper section. The brand new molded hopper section can have an enclosure that can contain the toner. The new hopper section and enclosure may be molded as a single piece out of plastic. The enclosure that is built into the hopper section can have port openings to install the toner. A seal can be attached to the enclosure over the port openings. Once toner is sealed within the enclosure of the new hopper section it can then be mated with the opposite OEM section to make a whole hopper. When the cartridge is ready to be used the seal can either be removed from the enclosure manually by the end user or can be removed automatically by the printer depending on the design of the seal. Toner will then be free to flow from the enclosure and to the developing components.

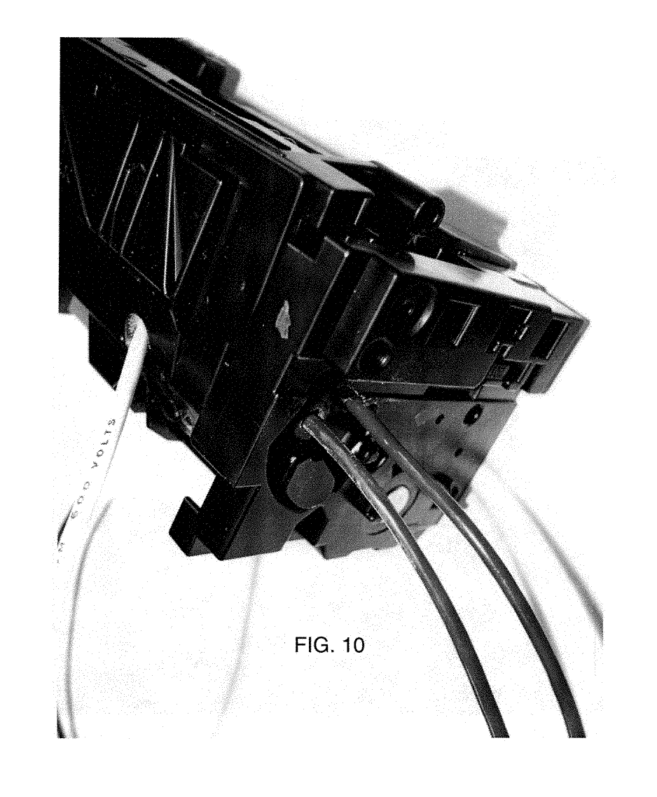

In another aspect of the present invention, a new bag with an interlocking seal can be used to contain the toner within the cartridge. The bag can be made out of plastic, foil, or any other suitable flexible material. The new bag can be installed within the cartridge using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. Toner can also be added to the bag through an interlocking seal port. The interlocking seal port can be comprised of two halves of the bag that lock together through some locking method. An example would be a zip lock bag or a zipper on a jacket. Locking the two halves together would seal the toner within the bag. A pull string or ribbon can be attached to the zipper on the bag. The string or ribbon can be fed through a hole or slot on the hopper. See FIG. 10, for example. The end user can manually pull on the string or ribbon prior to installing the cartridge into the printer which will open up the interlocking port on the bag and allowing toner to flow freely to the developing components. The end of the string/ribbon can also be attached to the agitator shaft. When the cartridge is installed into the printer the agitator will spin which will automatically pull the string/ribbon and open the interlocking port of the bag allowing toner to flow freely to the developing components.

The HP M553 (508A/508X) cartridge uses a conductive plastic material in place of traditional metal material for the cartridge contacts. When removing the hopper contact side end plate the conductive plastic contact that mates with the dr. blade can be easily damaged or broken. This contact is vital for being able to print pages with acceptable print quality. This document discloses methods for repairing a damaged or broken dr. blade contact.

Method for Repairing a Broken Dr. Blade Contact

With the dr. blade screw removed, the original conductive plastic in place in the hopper, and the end plate installed, drill a small hole through the center of the dr. blade contact area. The hole should be drilled until the drill bit can be seen through the dr. blade screw hole. Install the dr. blade screw. Then insert a small pin/post made out of metal, conductive plastic, or any other suitable conductive material into the hole that was drilled. This pin/post will serve as the conductive bridge from the end plate to the dr. blade screw.

With the dr. blade screw installed and the original conductive plastic removed from the hopper, a small pin/post made out of metal, conductive plastic, or any other suitable conductive material can be inserted into the existing hole. The pin/post must butt up against the dr. blade screw on one end while the other end butts up against the end plate. This pin/post will serve as the conductive bridge from the end plate to the dr. blade screw.

With the dr. blade screw installed, the original conductive plastic removed from the hopper, and the end plate installed, inject conductive grease, lubricant, silicon, or other suitable conductive substance through the existing hole. The conductive substance will serve as the bridge from the end plate to the dr. blade screw.

With the dr. blade screw installed and the original conductive plastic in place in the hopper, apply a generous amount of conductive grease, lubricant, silicon, or other suitable conductive substance on to the end of the original conductive plastic in the hopper. Install the end plate. The conductive substance will serve as the bridge from the end plate to the original conductive plastic.

With the dr. blade screw removed and the original conductive plastic removed from the hopper, a small pin/post made out of metal, conductive plastic, or any other suitable conductive material can be inserted into the existing hole. Replace the original dr. blade screw with a self tapping screw. Thread the screw into the newly installed conductive pin/post. The opposite end of the conductive pin/post will butt up against the conductive plastic on the end plate once it is installed. The pin/post will serve as the conductive bridge from the end plate to the dr. blade screw.

With the dr. blade screw installed, the original conductive plastic in place in the hopper, and the end plate installed, screw in a self tapping screw through the center of the hole on the end plate for the dr. blade contact. The screw should be long enough to reach the original conductive plastic that is in the hopper. The screw will serve as the bridge from the end plate to the original conductive plastic.

Replace all contact with standard metal contacts. Break out existing conductive plastic and use metal. This would create a metal to metal contact in the machine for input of the voltages.

### Methods for Replacing Toner Adder Roller

Pull the toner adder roller shaft out through the hole in the bearing plate on the side of the cartridge. In the process of pulling the shaft through the hole, the foam will be ripped off the shaft and will remain in the hopper. The foam can then be freely removed from the hopper after the shaft has been fully removed. The new toner adder roller can be composed of a two piece shaft. Using a two piece shaft prevents needing to remove the any of the adder roller bearing plates or any of the felts and foams from the hopper.

The toner adder roller could also be replaced by breaking the welds on the clear bearing surface and re-gluing these back in place once the new toner adder roller has been installed. The adhesion method of the clear toner adder roller bearing may incorporate ultrasonic methods, laser adhesion, multi-sided tape, or solvent bonding.

Some of the feasible methods of resealing a HPM553 (508A/508X) hopper to prevent toner from leaking out of the hopper during shipping and handling requires the remanufacturer to split the hopper section into two pieces along the ultrasonically welded area. This document will disclose methods for fastening the two hopper sections of a HP M553 (508A/508X) cartridge back together so that it will once again function in the printer without leaking toner.

### Methods for Fastening the Two Hopper Sections

A thin bead of glue, caulk, or silicon can be applied along the perimeter of one of the hopper halves or both hopper halves where the hoppers were originally ultrasonically welded. The hoppers can then be joined together. The hopper should be set to the side to allow the glue, caulk, or silicon to set before continuing with remanufacturing.

A malleable material such as but not limited to silicon, felt, or foam with adhesive on either side of the material can be applied along the perimeter of one of the hopper halves where the hoppers were originally ultrasonically welded. The hoppers can then be joined together.

The two hopper halves can be joined together and then a source of heat can be applied to the area where the hoppers were originally ultrasonically welded. The heat can be applied through ultrasonically welding the hoppers back together. A form of heat can be applied to the plastic on both hoppers thus melting and fusing them together. A form of heat can spot weld the two hopper halves along the perimeter. Also the halves can be heat staked together.

The two hopper halves can be joined together and then metal (or other suitable material) spring clips can be placed around the perimeter of the joined hopper. The spring clips will have tension on them when applied to the joined hopper. The tension will keep the joined hopper from leaking around its perimeter. The clips can be held in place on the joined hoppers by their own high tension or they can fixed in place using adhesive, glue, or screws.

The two hopper halves can be joined together and then holes drilled through the joined hopper sections. Bolts can be run through the drilled holes and then the joined hopper sections can be tightened down together using nuts. Screws can be used in place of the bolts. If using self tapping screws then drilling holes is not necessary.

The two hopper halves can be joined together and then thin straps made out of plastic, rubber, nylon or any other suitable flexible material can be wrapped around the two joined hopper halves. The strap can be adjustable similar to a belt or a ratcheting strap. The strap can also be flexible similar to a rubber band or bungee cord. The force applied by the strap would keep the two hopper halves pressed together preventing it from leaking.

Methods for Splitting Hopper into Two Sections

Fixture can hold one half of the hopper while pulling the second half of the hopper. Heat and/or blades can be applied to the welded areas. The combination of pressure, heat and/or blades would separate the two hopper halves.

Use a sharp edged tool or blade to pry between hopper surfaces separating the weld.

Use a heat device to soften up the weld area and separate the two hopper halves.

Use a sonic cutter between the two hopper halves where they are sonically welded. The sonic cutter will separate the two halves by vibrating and cutting with the edge of the blade at the same time.

Methods for Filling Hopper with Toner

Use a heat stake, soldering iron, or a boring tool to make a hole in the hopper.

Fill the hopper with toner and place an adhesive seal or plug to reseal the hole.

Remove the agitator drive gear from the hopper. Fill toner in the hopper through the hole in the side of the hopper from where the agitator was removed. The agitator gear can be removed by pulling with your hand or prying with a tool from the outside of the hopper. The agitator gear can also be removed by depressing the locking clips on the agitator shaft if the hopper as been split into two halves.

Cut, drill, or melt a hole in the center of the agitator drive gear using a blade, rotary tool, or heat tool. Fill the hopper with toner through the newly created hold. Seal the hole using an adhesive seal or plug.

Cartridge seals prevent toner from leaking out of the cartridge during shipping and handling. Cartridge seals are removed either by the end user or automatically by the printer prior to printing. During remanufacturing of a cartridge it is necessary to replace the cartridge seal so that the cartridge can once again be shipped without the fear of toner leaking out of the cartridge. The HP M553 (508A/508X cartridge) has an internal seal which is much different than most traditional seals and it is removed automatically by the printer before printing. This document will disclose methods for sealing the HP M553 (508A/508X) cartridge during the remanufacturing process.

### Methods for Sealing Cartridge

Clean the residual toner from the hopper and the original OEM seal. Apply an adhesive (such as glue or 2 sided tape) to the original OEM seal. (Note: if using 2 sided tape the adhesive connected to the original OEM seal must be stronger than the adhesive on the side connecting to the plastic within the cartridge). Stick the OEM original seal back in the position its originally in before being removed, covering the toner port holes that lead to the developing section of the cartridge.

The OEM seal can be trimmed to remove the portion where the seal was originally applied to the port holes. A new never used portion of the OEM seal can then be applied covering the port holes using adhesive, glue, or a heat method such as heat stake or ultrasonic welding.

Remove the original OEM seal from the toner agitator shaft. A new seal can be installed in its place. It can consist of thin flexible plastic material with a thin layer of adhesive and release liner covering the adhesive. Attach the new seal using adhesive, glue, or heat method to the toner hopper plastic covering the toner port holes that lead to the developing section of the cartridge. The end of the seal can be attached to the agitator shaft. Once the printer begins rotating the agitator, the seal will be pulled thus opening the port and allowing toner to flow freely to the developing components. Depending on the shape or design of the seal it can become a toner agitator paddle (much like the OEM) or the ribbon or pull strip can be coiled/wrapped around the agitator and serve no further purpose.

Remove the original OEM seal from the toner agitator shaft. A new seal can be installed in place of the OEM. It can consist of thin flexible plastic material with a thin layer of adhesive and release liner covering the adhesive. Attach the new seal using adhesive, glue, or heat method to the toner hopper plastic covering the toner port holes that lead to the developing section of the cartridge. The end of the seal can be pulled manually by the end user prior to printing. To allow the end user to pull the seal manually a slit can be cut in the hopper using a blade or rotary tool to feed the end of the seal out of the hopper or the seal can be fed through the existing opening from where the hopper was split. With the end of the seal extending out of the hopper the end user can now pull the seal prior to installing the cartridge into the printer thus opening the port on the barrier and allowing toner to flow freely to the developing components.

A plug can be installed to cover the existing toner port holes. The plug can be made out of rubber, silicon, cloth, felt, foam, or any other suitable malleable material. The existing OEM seal can be attached to the back of the plug using glue, adhesive, or heat method. The existing OEM seal can also be removed and replaced with a new flexible material and this new material can be attached to the agitator shaft on one end will the other end is attached to the plug using adhesive, glue, heat method, or it can be integrated into the plug. Once the printer begins rotating the agitator, the plug will be pulled thus opening the port and allowing toner to flow freely to the developing components.

Remove the developer roller and toner adder roller from the cartridge. Install a manual pull style seal using adhesive, glue, or a heat method over the toner port holes on the side closest to the developing section of the hopper. The end of the seal can be pulled manually by the end user prior to printing. To allow the end user to pull the seal manually a slit can be cut in the hopper using a blade or rotary tool to feed the end of the seal out of the hopper or the end of the seal can be fed through the existing opening from where the hopper was split. With the end of the seal extending out of the hopper the end user can now pull the seal prior to installing the cartridge into the printer thus opening the port on the barrier and allowing toner to flow freely to the developing components.

Remove the developer roller and toner adder roller from the cartridge. Clean out all residual toner from the hopper. Cut a slot across the bottom side of the hopper. Slot can be cut using a blade or rotary bit. Install a manual pull style seal using adhesive over the toner port holes on the side closest to the developing section of the hopper. Insert the pull tab of the pull seal through the slot on the bottom side of the cartridge. End user can remove the seal by pulling on the tab of the pull seal or the pull tab can be fixed to the shipping protector and the end user can remove the seal the same time they remove the shipping cover.

Toner can be filled directly into the hopper. The OEM used seal can remain in its current position. The developing components within the HP M553 (508A/508X) cartridge all contact each other therefore providing a seal/barrier that prevents toner from leaking out of the cartridge.

A bag and seal can be used to seal the toner within the cartridge. The bag can be made out of plastic, foil, or any other suitable flexible material. The bag can be installed within the hopper by using adhesive, glue, or a heat method. The bag can have a port or slit for adding toner to the bag. The port or slit can be sealed by a screw on cap, plug, adhesive, glue, or heat method such as heat stake or ultrasonic welding. A seal can be either integrated into the bag or can be attached to the outer portion of the bag via adhesive, glue, or heat method. The end of the seal can be attached to the agitator shaft. Once the printer begins rotating the agitator the seal will be pulled thus opening the port on the bag and allowing toner to flow freely to the developing components. Depending on the shape or design of the seal it can become a toner agitator paddle (much like the OEM) or the ribbon or pull strip can be coiled/wrapped around the agitator and serve no further purpose.

A hard casing can be used to seal the toner within the cartridge. The casing can be made of plastic, metal, or any other suitable rigid material. The casing can be attached within the cartridge by adhesive, glue, or a heat method. Toner can be filled into the casing through the port prior to installing a seal or through a separate port that can be sealed using a screw on cap, plug, adhesive, glue, or heat method. A seal can be attached to the outer portion of the casing via adhesive, glue, or heat method. The end of the seal can be attached to the agitator shaft. Once the printer begins rotating, the agitator the seal will be pulled thus opening the port on the casing and allowing toner to flow freely to the developing components. Depending on the shape or design of the seal it can become a toner agitator paddle (much like the OEM) or the ribbon or pull strip can be coiled/wrapped around the agitator and serve no further purpose.

Removable seal could be designed with 2 different options for removal. Providing 2 different options would give the end user the choice to use the method they prefer. The seal could be attached to a bag, a hard casing, or the original OEM barrier within the hopper. The seal would have 2 different methods for removing the seal so that toner could flow freely to the developing components. One option would be to attach the seal to the agitator so that the seal is removed automatically when the printer engages the cartridge. The other option would be a pull ribbon that could be extended out from the cartridge either through a newly created slot or an existing slot. The pull ribbon would be pulled manually by the end user to remove the seal. Once the end user has decided the method in which they would like to pull the seal the other option could be removed from the seal by the end user to prevent issues.

OEM hopper could be completely replaced with a new hopper. The new hopper could be designed with a location to place an internal removable seal that attaches to the agitator shaft and/or it could be designed with a location to place a removable seal behind the toner adder roller. With the seal placed behind the toner adder roller it would need to have a slot in the cartridge to insert the seal pull ribbon so that the seal could be removed from the cartridge allowing toner to flow freely to the developing components.

A new bag and removable seal can be used to seal the toner within the cartridge. The bag can be made out of plastic, foil, or any other suitable flexible material. The new bag can be installed within the cartridge using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. A seal can be either integrated into the bag or can be attached to the outer portion of the bag via adhesive, glue, or heat method. The end of the seal can be attached to the original OEM seal which is still attached to the agitator shaft. Once the printer begins rotating the agitator, the OEM seal will pull the seal that is attached or incorporated into the bag thus opening the port on the bag and allowing toner to flow freely to the developing components. The seal that is removed from the bag will remain attached to the OEM seal and become an agitator paddle within the hopper.

A new bag can be used to seal the toner within the hopper. The bag can be made out of plastic, foil, or any other suitable flexible material. The new bag can be installed within the hopper using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. A new plastic hopper can be designed to have a slot that runs the length of the cartridge or the OEM hopper can be modified to have a slot that runs the length of the cartridge. A blade with a handle can be attached or incorporated in the slot. The end user can move the handle down the length of the slot and the blade can cut open the bag allowing the toner to flow freely to the developing components. Or the end user can use their own blade to cut the bag open through the slot rather than having a blade incorporated in the hopper.

A new hopper section with integrated enclosure for containing the toner can be used. The OEM hopper is made up of 2 sections that are sonically welded together. Once the OEM hopper has been split into 2 sections, either one of the OEM hopper section can be pared with a brand new molded hopper section. The brand new molded hopper section can have an enclosure that can contain the toner. The new hopper section and enclosure would be molded as 1 piece out of plastic. The enclosure that is built into the hopper section can have port openings to install the toner. A seal can be attached to the enclosure over the port openings. Once toner is sealed within the enclosure of the new hopper section it can then be mated with the opposite OEM section to make a whole hopper. When the cartridge is ready to be used the seal can either be removed from the enclosure manually by the end user or can be removed automatically by the printer depending on the design of the seal. Toner will then be free to flow from the enclosure and to the developing components.

A new bag with an interlocking seal can be used to contain the toner within the cartridge. The bag can be made out of plastic, foil, or any other suitable flexible material. The new bag can be installed within the cartridge using the same method the OEM is attached or by using adhesive, glue, or a heat method. The bag can have a port or slit for adding toner to the bag. The port or slit can be sealed by a screw on cap, plug, adhesive, glue, or heat method such as heat stake or ultrasonic welding. Toner can also be added to the bag through the interlocking seal port. The interlocking seal port can be comprised of 2 halves of the bag that lock together through some locking method. An example would be a zip lock bag or a zipper on a jacket. Locking the 2 halves together would seal the toner within the bag. A pull string or ribbon can be attached to the zipper on the bag. The string or ribbon can be fed through a hole or slot on the hopper. The end user can manually pull on the string or ribbon prior to installing the cartridge into the printer which will open up the interlocking port on the bag and allowing toner to flow freely to the developing components. The end of the string/ribbon can also be attached to the agitator shaft. When the cartridge is installed into the printer the agitator will spin which will automatically pull the string/ribbon and open the interlocking port of the bag allowing toner to flow freely to the developing components.

### Method for Removing Hopper End Plate

Drill surface of plate at pin location just enough to separate from glued pin. Remove plate pulling straight out.

Hold cartridge in place using a fixture. Pull on the end plates using pneumatics with a linear motion. Use heat and/or blades to aid in separating the end plates from the hopper.

Use a tool that latches on to the end plate. The tool would be composed of a slide hammer. The slide hammer would apply the force to the portion of the tool that is latched to the end plate which would break the weld and separate the end plate from the hopper.

Use a tool to pry the end plates until the weld breaks. Once the weld is broken then they can be removed from the hopper. The tool can be a flat blade screw driver, a blade or any other comparable sharp/pointed edged tool.

The location where the end plate is welded to the hopper can be heated to the point where it can be separated. Heat can be applied by a heat gun, soldering iron, or any other comparable heat device.

Cut the welded portion of the end plate using a blade, rotary tool, pliers, side cutters, scissors or other comparable cutting tool. Remove the end plate from the hopper.

The HP M252/277 (201A/201X) cartridge uses a conductive plastic material in place of traditional metal material for the cartridge contacts. When removing the hopper contact side end plate the conductive plastic contact that mates with the dr. blade can be easily damaged or broken. This contact is vital for being able to print pages with acceptable print quality. This document discloses methods for repairing a damaged or broken dr. blade contact.

Methods for Repairing a Broken Dr. Blade Contact

With the dr. blade screw removed, the original conductive plastic in place in the hopper, and the end plate installed, drill a small hole through the center of the dr. blade contact area. The hole should be drilled until the drill bit can be seen through the dr. blade screw hole. Install the dr. blade screw. Then insert a small pin/post made out of metal, conductive plastic, or any other suitable conductive material into the hole that was drilled. This pin/post will serve as the conductive bridge from the end plate to the dr. blade screw.

With the dr. blade screw installed and the original conductive plastic removed from the hopper, a small pin/post made out of metal, conductive plastic, or any other suitable conductive material can be inserted into the existing hole. The pin/post must butt up against the dr. blade screw on one end while the other end butts up against the end plate. This pin/post will serve as the conductive bridge from the end plate to the dr. blade screw.

With the dr. blade screw installed, the original conductive plastic removed from the hopper, and the end plate installed, inject conductive grease, lubricant, silicon, or other suitable conductive substance through the existing hole. The conductive substance will serve as the bridge from the end plate to the dr. blade screw.

With the dr. blade screw installed and the original conductive plastic in place in the hopper, apply a generous amount of conductive grease, lubricant, silicon, or other suitable conductive substance on to the end of the original conductive plastic in the hopper. Install the end plate. The conductive substance will serve as the bridge from the end plate to the original conductive plastic.

With the dr. blade screw removed and the original conductive plastic removed from the hopper, a small pin/post made out of metal, conductive plastic, or any other suitable conductive material can be inserted into the existing hole. Replace the original dr. blade screw with a self tapping screw. Thread the screw into the newly installed conductive pin/post. The opposite end of the conductive pin/post will butt up against the conductive plastic on the end plate once it is installed. The pin/post will serve as the conductive bridge from the end plate to the dr. blade screw.

With the dr. blade screw installed, the original conductive plastic in place in the hopper, and the end plate installed, screw in a self tapping screw through the center of the hole on the end plate for the dr. blade contact. The screw should be long enough to reach the original conductive plastic that is in the hopper. The screw will serve as the bridge from the end plate to the original conductive plastic.

Replace all contact with standard metal contacts. Break out existing conductive plastic and use metal. This would create a metal to metal contact in the machine for input of the voltages.

### Methods for Replacing the Cartridge Chip

Toner cartridge chips communicate with laser printers to let them know when the cartridge is running low on toner and when the cartridge needs replacing. Once a chip communicates to the printer that the cartridge needs replacing then the chip is considered “spent.” A spent chip will always display that the cartridge needs replacing even if the cartridge is refilled with toner. So when remanufactures recharge a cartridge they replace the spent chip with a new chip. This document will disclose methods for replacing the cartridge chip on a HP M252/277 (201A/201X) cartridge.

The cartridge end plate that houses the cartridge chip is attached to the cartridge using ultrasonic welding. Remove end plate from cartridge using a pry bar, angle blade, or flat blade screw driver by gently prying around its perimeter until it breaks loose from the cartridge. Remove slide the “spent” chip out of its designated slot on the end plate and install a new chip. Reattach the end plate back onto the cartridge.

The cartridge end plate that houses the cartridge chip is attached to the cartridge using ultrasonic welding. Remove end plate from cartridge using a pry bar, angle blade, or flat blade screw driver by prying around its perimeter until it breaks loose from the cartridge. The cartridge end plate as a tendency to crack during the removal process. Install the new chip into a new end plate and attach the new end plate to the cartridge.

The cartridge end plate that houses the cartridge chip is attached to the cartridge using ultrasonic welding so it is difficult to remove the end plate without damaging it. Leaving the end plate attached to the cartridge, remove the plastic material from the end plate that encases the chip using side cutters, a blade, or rotary tool. Remove the “spent” chip from the end plate. Install the new chip. Chip can be attached to the end plate by 2 sided adhesive or glue.

The cartridge end plate that houses the cartridge chip is attached to the cartridge using ultrasonic welding so it is difficult to remove the end plate without damaging it. Leaving the end plate attached to the cartridge, remove the plastic material from the end plate that prevents the chip from sliding out of its designated slot using pliers, side cutters, a blade, or rotary tool. Slide the “spent” chip out of its designated slot in the end plate. Install the new chip into the designated slot. The chip can be attached to the end plate by 2 sided adhesive or glue.

The cartridge end plate that houses the cartridge chip is attached to the cartridge using ultrasonic welding so it is difficult to remove the end plate without damaging it. Leaving the end plate attached to the cartridge, attach a new chip on top of the “spent” chip. The new chip can be attached to the “spent” chip using 2 sided adhesive or glue.

The designated space for the cartridge chip is very limited. A new chip may require more space than what is available within the designated space. Remove the “spent” chip using the one of the methods mentioned above. Install a blank chip board with contacts for interfacing with the printer in the designated slot for the chip using adhesive or glue. Attach leads to the contacts on the blank board that lead to a chip with the functioning components. The chip with the functioning components can be attached anywhere on the outer portion of the cartridge that does not interfere with the cartridge's functionality within the printer. The chip with the functioning components can be attached using adhesive or glue.

The cartridge end plate that houses the cartridge chip is attached to the cartridge using ultrasonic welding so it is difficult to remove the end plate without damaging it. Leaving the end plate attached to the cartridge, remove the plastic material from the end plate that prevents the chip from sliding out of its designated slot using pliers, side cutters, a blade, or rotary tool. Slide the “spent” chip out of its designated slot in the end plate. Install the new chip into the designated slot. The chip can be held in place using a piece made from plastic or other suitable material to clip or be adhered to remaining “fin” that was cut to allow the “spent” chip to be removed, the cartridge body or end plate.

The cartridge end plate that houses the cartridge chip is attached to the cartridge using ultrasonic welding so it is difficult to remove the end plate without damaging it. Leaving the end plate attached to the cartridge, remove the plastic material from the end plate that prevents the chip from sliding out of its designated slot using pliers, side cutters, a blade, or rotary tool. Slide the “spent” chip out of its designated slot in the end plate. Install the new chip into the designated slot. The designated space for the cartridge chip is very limited. A new chip may require more space than what is available within the designated space. The material that was removed would allow for a larger chip to be installed and attached with adhesive, glue, or using a piece made from plastic or other suitable material to clip or be adhered to remaining “fin” that was cut to allow the “spent” chip to be removed, the cartridge body or end plate.

Methods for Splitting Hopper into Two Sections

Fixture can hold one half of the hopper while pulling the second half of the hopper. Heat and/or blades can be applied to the welded areas. The combination of pressure, heat and/or blades would separate the two hopper halves.

Use a sharp edged tool or blade to pry between hopper surfaces separating the weld.

Use a heat device to soften up the weld area and separate the two hopper halves.

Use a sonic cutter between the two hopper halves where they are sonically welded. The sonic cutter will separate the two halves by vibrating and cutting with the edge of the blade at the same time.

### Methods for Fastening the Two Hopper Sections

Some of the feasible methods of resealing a HP M252/277 (201A/201X) hopper to prevent toner from leaking out of the hopper during shipping and handling requires the remanufacturer to split the hopper section into two pieces along the ultrasonically welded area. This document will disclose methods for fastening the two hopper sections of a HP M252/277 (201A/201X) cartridge back together so that it will once again function in the printer without leaking toner.

A thin bead of glue, caulk, or silicon can be applied along the perimeter of one of the hopper halves or both hopper halves where the hoppers were originally ultrasonically welded. The hoppers can then be joined together. The hopper should be set to the side to allow the glue, caulk, or silicon to set before continuing with remanufacturing.

A malleable material such as but not limited to silicon, felt, or foam with adhesive on either side of the material can be applied along the perimeter of one of the hopper halves where the hoppers were originally ultrasonically welded. The hoppers can then be joined together.

The two hopper halves can be joined together and then a source of heat can be applied to the area where the hoppers were originally ultrasonically welded. The heat can be applied through ultrasonically rewelding the hoppers back together. A form of heat can be applied to the plastic on both hoppers thus melting and fusing them together. A form of heat can spot weld the two hopper halves along the perimeter. Also the halves can be heat staked together.

The two hopper halves can be joined together and then metal (or other suitable material) spring clips can be placed around the perimeter of the joined hopper. The spring clips will have tension on them when applied to the joined hopper. The tension will keep the joined hopper from leaking around its perimeter. The clips can be held in place on the joined hoppers by their own high tension or they can fixed in place using adhesive, glue, or screws.

The two hopper halves can be joined together and then holes drilled through the joined hopper sections. Bolts can be run through the drilled holes and then the joined hopper sections can be tightened down together using nuts. Screws can be used in place of the bolts. If using self tapping screws then drilling holes is not necessary.

The two hopper halves can be joined together and then thin straps made out of plastic, rubber, nylon or any other suitable flexible material can be wrapped around the two joined hopper halves. The strap can be adjustable similar to a belt or a ratcheting strap. The strap can also be flexible similar to a rubber band or bungee cord. The force applied by the strap would keep the two hopper halves pressed together preventing it from leaking.

### Methods for Installing Cartridge End Plates

Drill holes at any location through the end plates and cartridge that does not adversely affect the cartridge's printing ability. Insert a plastic or metal pin with or without a shoulder or a screw into the drilled hole which holds end plates aligned and in place.

Apply glue or adhesive to the end plates and/or hopper and press the end plates back into their original position on the cartridge. Let the cartridge sit until the glue or adhesive has fully bonded.

The end plates can be joined together with the cartridge using a heat source. The heat can be applied through ultrasonically welding, soldering iron, heat stake, heat gun, or any other comparable source of heat.

The end plates can be attached to the cartridge using a thin strip of material that is attached to the end plates on one end and attached to the cartridge on the other. The thin strip of material can be made out of plastic, metal, or any other comparable material. The strip of material can be attached to either the end plates or cartridge using glue, adhesive, or self-taping screws.

The end plates can be attached to the hopper using clips. The clip can be supported on one end by glue, adhesive, or a screw while the other end wraps over a ledge (similar to a hook in shape) that is either on the cartridge or on the end plates.

The end plates can be joined with the cartridge using thin straps made out of plastic, rubber, nylon or any other suitable flexible material. The straps can be wrapped around the end plates and cartridge. The strap can be adjustable similar to a belt or a ratcheting strap. The strap can also be flexible similar to a rubber band or bungee cord. The force applied by the strap would keep the end plates and cartridge joined together.

Attach new end plates to the cartridge that have holes predrilled for locating screws. Insert self taping screws through the predrilled holes on the end plates and attach them to the cartridge.

### Methods for Installing Hopper End Plate

Drill holes at any location through the end plate and hopper that does not adversely affect the cartridge's printing ability. Insert a plastic or metal pin with or without a shoulder or a screw into the drilled hole which holds end plate aligned and in place.

Apply glue or adhesive to the end plate and/or hopper and press the end plate back into its original position on the hopper. Let the cartridge sit until the glue or adhesive has fully bonded.

The end plate can be joined together with the hopper using a heat source. The heat can be applied through ultrasonically welding, soldering iron, heat stake, heat gun, or any other comparable source of heat.

The end plate can be attached to the hopper using a thin strip of material that is attached to the end plate on one end and attached to the hopper on the other. The thin strip of material can be made out of plastic, metal, or any other comparable material. The strip of material can be attached to either the end plate or hopper using glue, adhesive, or self taping screws.

The end plate can be attached to the hopper using clips. The clip can be supported on one end by glue, adhesive, or a screw while the other end wraps over a ledge (similar to a hook in shape) that is either on the hopper or on the end plate.

The end plate can be joined with the hopper using thin straps made out of plastic, rubber, nylon or any other suitable flexible material. The straps can be wrapped around the end plate and hopper. The strap can be adjustable similar to a belt or a ratcheting strap. The strap can also be flexible similar to a rubber band or bungee cord. The force applied by the strap would keep the end plate and hopper joined together.

### Methods for Installing Cartridge End Plates

Hold cartridge in place using a fixture. Pull on the end plates using pneumatics with a linear motion. Use heat and/or blades to aid in separating the end plates from the cartridge.

Use a tool that latches on to the end plate. The tool would be composed of a slide hammer. The slide hammer would apply the force to the portion of the tool that is latched to the end plates which would break the welds and separate the end plates from the hopper.

Use a tool to pry the end plates until the welds break. Once the welds are broken then they can be removed from the hopper. The tool can be a flat blade screw driver, a blade or any other comparable sharp/pointed edged tool.

The locations where the end plates are welded to the cartridge can be heated to the point where they can be separated. Heat can be applied by a heat gun, soldering iron, or any other comparable heat device.

The locations where the end plates are welded to the cartridge can be drilled using a rotary tool.

What is claimed is:

1. A method of repairing a doctor blade contact of a toner cartridge comprising a toner hopper having a toner bag and not having a seal port, the method comprising:
removing a doctor blade screw;
drilling a hole through a doctor blade contact area;
installing doctor blade screw; and
insert conductive post into drilled hole;

2. A method of replacing a toner adder roller having a toner adder roller shaft comprising:
removing the toner adder roller shaft from a hole in a bearing plate; and
installing a toner adder roller shaft comprising a first piece and a second piece.
